(19) United States
(12) Patent Application Publication
(10) Pub. No.: US 2023/0403962 A1
(43) Pub. Date: Dec. 21, 2023

(54) Agricultural Implement for Soil Working and Method of Determining Working Depth of Soil Working Agricultural Implement

(71) Applicant: Väderstad Holding AB, Väderstad (SE)

(72) Inventors: Jakob Lindberg, Linköping (SE); Erik Wågbrant, Skänninge (SE); Stefan Vålberg, Linköping (SE); Dan Persson, Vikingstad (SE)

(21) Appl. No.: 18/034,130

(22) PCT Filed: Oct. 27, 2021
(86) PCT No.: PCT/SE2021/051079

§ 371 Date: Apr. 27, 2023

(30) Foreign Application Priority Data
Oct. 30, 2020 (SE) 2051267-9

(51) Int. Cl. A01B 63/114; A01B 63/00; A01B 63/16

(52) U.S. Cl. CPC A01B 63/114; A01B 63/16; A01B 63/008

(57) ABSTRACT

An agricultural implement (1) for soil working, comprising a frame (10, 101, 10a, 10b, 10c, 10d, 10e), a number of ground-engaging tools (12, 13) carried by the frame, at least one rolling ground support (11a, 11b), the height position of which is adjustable relative to the frame, a height sensor (31) for contact-free measuring of the height position of the frame relative to a ground surface (G1), and a control unit (15), arranged to receive a signal from the height sensor (31) and to control the height position of the rolling ground support (11a, 11b). At least one of the tools (12, 13) is resilient relative to the frame (10, 101, 10a, 10b, 10c, 10d, 10e). A tool position sensor (32) is arranged to measure the orientation of the tool (12, 13), and the control unit (15) is arranged to receive a signal from the tool position sensor (32) and to calculate a work depth for said tool (12, 13) based on the signal from the height sensor (31) and based on the signal from the tool position sensor (32). Furthermore, a method of determining the work depth of a soil-working agricultural implement is shown.

### TECHNICAL FIELD

This document relates to an agricultural implement for soil working, such as primarily a cultivator, a harrow or a plough, but also seed drills or other agricultural implements intended for distribution of material to the ground on which the agricultural implement is travelling.

The document also relates to a method for determining the work depth of soil-working agricultural implements, based on which the work depth can be controlled.

### BACKGROUND

When working the soil using agricultural implements, it is desirable to be able to control and maintain a predetermined work depth, e.g. the depth at which the ground-engaging tools of the agricultural implement are working.

It is known, for example from US2017251587, EP1273216 and US2018271020, to use radar for measuring a distance between the agricultural implement frame and the ground and for adjusting a distance between a support wheel contacting the ground and the frame in order to increase or decrease the work depth of the tools.

However, many agricultural implements have tools that are spring-suspended, and which can deflect rearward, in some cases when colliding with obstacles, but also as a result of the resistance that the ground exerts on the tool during travel. This deflection can lead to the tip of the tool ending up substantially higher up than expected, based on the measurement of the distance, which can lead to the tilling not taking place at the expected depth.

Consequently, there is a need for an agricultural implement which can determine and control the work depth more accurately.

### SUMMARY

One object is to provide a way of determining and controlling the work depth of a soil-working agricultural implement with greater precision.

The invention is defined by the attached independent patent claims. Embodiments are set forth in the dependent claims, in the description that follows and in the accompanying drawings.

According to a first aspect, an agricultural implement for soil working is provided, comprising a frame, a number of ground-engaging tools carried by the frame, at least one rolling ground support, the height position of which is adjustable relative to the frame, a height sensor for contact-free measuring of the height position of the frame relative to a ground surface, and a control unit, arranged to receive a signal from the height sensor and to control the height position of the rolling ground support. At least one of the tools is resilient relative to the frame. A tool position sensor is arranged to measure the orientation of said spring-loaded tool in relation to the frame, and the control unit is arranged to receive a signal from the tool position sensor and to calculate a work depth for said spring-suspended tool based on the signal from the height sensor and based on the signal from the tool position sensor.

The frame can comprise one or more tool-carrying frame sections. In the event of more than one frame section, the frame sections can be moveable in relation to each other. For example, the height of each frame section relative to the ground can be adjustable, either by using a controllable rolling ground support connected to the frame section, or by one or more actuators setting the position of the frame section in relation to at least one additional frame section.

Making a frame section adjustable relative to a rolling ground support and/or another frame section is known per se.

It will be appreciated that the control unit can be a control unit for a part of the agricultural implement, for the entire agricultural implement or a control unit for the unit, which can be arranged in the tractor vehicle. It will also be appreciated that some of the tasks carried out by the control unit can be carried out by a processing unit placed elsewhere, such as cloud-based.

“Ground-engaging tools” means tools which engage the ground while the agricultural implement is travelling on it.

The “rolling ground support” can be one or more support wheels or packer rollers. “Support wheels” means the type of wheels used for at least partly carrying the weight of an agricultural implement while the agricultural implement is in a working mode. Such support wheels can also be used when the agricultural implement is in a transport mode.

Sensors for measuring height are known per se.

The tool being resilient relative to the frame means that the tool can spring in relation to the frame. For example, the tool itself can be rigid, but attached relative to the frame using a spring, which can bias the tool to a rest position. Alternatively, the tool, or parts thereof, can in themselves be resilient, so that the tool can deflect out from a rest position.

It is possible to calculate an actual work depth of the tool by means of measuring both the height to the ground and the orientation of the tool, with knowledge of the geometry and the spring characteristics of the tool. This type of work depth can be used for controlling the agricultural implement, either automatically or via user input. Thus it is possible to provide more exact control of the work depth.

The control unit can be configured to control the height position of the rolling ground support based on the signal from the height sensor and based on the signal from the tool position sensor.

The agricultural implement can further comprise at least one height position sensor for the rolling ground support, wherein the control unit can be arranged to receive a signal from the height position sensor and to calculate the work depth also based on the signal from the height position sensor.

A height position sensor can be used to increase the signal reliability by validating signals from other sensors. In addition, the height position sensor can be used for detecting deviating conditions, for example, if the engagement of a support wheel with the ground ceases because the ground is too hard for the tool to penetrate at the desired work depth.

The height sensor can comprise at least one sensor selected from a group consisting of an ultrasonic sensor, a radar sensor and an optical sensor.

The tool position sensor can comprise at least one sensor selected from a group consisting of an ultrasonic sensor, a radar sensor, a light sensor, an angle sensor, a material load sensor and a camera-based sensor.

A material load sensor is a sensor for measuring the load on a material, such as a wire strain gauge, which can be arranged to measure a strain of a tool.

It will be appreciated that a combination of sensors selected from said group can be used.

The agricultural implement can further comprise a towing device, configured to be connected to a tractor vehicle using a tow bar or via a pair of lifting arms of a three-point linkage.

Each of the tools can be selected from a group consisting of a cultivator tine, a harrow tine, a levelling implement, a plough share, a harrow disc, a breaking-up disc, a furrow-opener, a seed disc, a fertilizer opener and a hoeing tool.

The agricultural implement can, on one and the same frame section, comprise at least two laterally separated height sensors and/or at least two laterally separated tool position sensors, wherein the control unit is configured to calculate the work depth based on signals from at least one of said at least two laterally separated height sensors and based on at least one of said at least two laterally separated tool position sensors.

By arranging two or more sensors on one and the same frame section, it is possible to reduce the action of individual tools on the adjustment of the work depth. For example, when using a plurality of sensors, it is possible to calculate the average ground distance and/or tool orientation, or, alternatively, to filter out errors or deviations.

It will be appreciated that, in an extreme case, all tools can be provided with tool position sensors. The number of tool position sensors does not need to correspond to the number of height sensors.

The agricultural implement can comprise at least two frame sections which are moveable in relation to each other, wherein at least two of the frame sections have a height sensor and/or a tool position sensor, wherein the control unit is configured to calculate said work depth for each of the frame sections.

At least two of the frame sections can have a rolling ground support associated with each respective frame section, and the control unit can be configured to individually control the height position of the rolling ground support of the respective frame sections.

According to a second aspect, a method of determining the work depth of a soil-working agricultural implement is provided. The method comprises providing an agricultural implement comprising a frame, a number of ground-engaging tools carried by the frame, and at least one rolling ground support, the height position of which is adjustable relative to the frame. The method further comprises measuring a distance between the frame and a ground surface, measuring the orientation of at least one of said tools relative to the frame, and based on said distance and said orientation, calculating the work depth of the tool.

The method can further comprise controlling said height position based on said distance and said orientation.

The method can further comprise measuring a height position for the rolling ground support relative to the frame and calculating the work depth also based on said position of the rolling ground support.

In the method, at least one of said measurements can be carried out continuously, intermittently or triggered by a predetermined event.

For example, measuring and/or controlling can be triggered by a change of direction of travel, by a certain position or by a change of any other sensor. For example, measuring the height position can be triggered by a change of a certain magnitude of the tool position sensor or vice versa. Controlling can, for example, be triggered in relation to a measured value being related in a certain way to a setpoint value, wherein tolerances and/or time between corrections can be taken into account. Thus, each deviation in the measured value does not need to generate correction of the work depth.

### BRIEF DESCRIPTION OF THE DRAWINGS

FIG. 1 shows a schematic side view of an agricultural implement.

FIG. 2 shows a schematic top view of an agricultural implement and a tractor vehicle connected thereto.

FIGS. 3a-3f show schematic top views of an agricultural implement in various configurations.

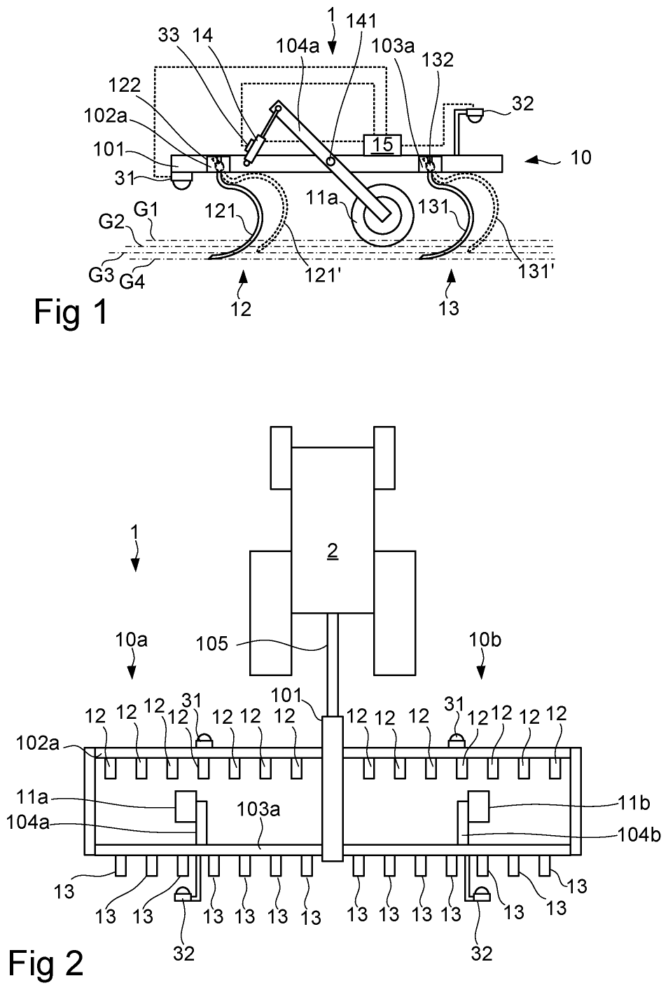

### DETAILED DESCRIPTION

Starting from an agricultural implement 1 in the form of a harrow, where the ground-engaging tools 12, 13 are in the form of harrow tines, an example will be given below.

The corresponding concept can be used in arbitrary soil-working agricultural implements, such as cultivators, harrows, ploughs and seed drills.

The ground-engaging tools 12, 13 can be in the form of cultivator tines, harrow tines, levelling implements, plough shares, harrow discs, furrow-openers, sowing discs, breaking-up discs, fertilizer discs and/or hoeing tools.

For agricultural implements which comprise more than one row of ground-engaging tools 12, 13, all the ground-engaging tools can be of the same type. Alternatively, different rows can have different types of tools.

The agricultural implement 1 has a frame 10, which can comprise one or more side frame sections 10a, 10b, which can be pivotally attached relative to a main frame 101. The frame 10 and/or the side frame sections 10a, 10b can carry a number of ground-engaging tools 12, 13, which can be arranged along transverse beams 102a, 103a; 102b, 103b.

In the examples shown, each side frame section 10a, 10b comprises a front tool-carrying transverse beam 102a, 102b and a rear tool-carrying transverse beam 103a, 103b.

Each frame section 10a, 10b can have one or more such tool-carrying transverse beams 102a, 103a; 102b, 103b, normally 1-6, 1-4 or 1-2 components.

In the event of two or more tool-carrying transverse beams 102a, 103a; 102b, 103b, the tools along each beam can be arranged at constant intervals. However, two tools of tool-carrying transverse beams 102a, 103a; 102b, 103b, separated in the direction of travel, can be displaced in relation to each other, so that a tighter tillage pattern can be provided.

The frame can further comprise a drawbar 105, at the distal end of which there is a coupling device for connecting to a tractor vehicle 2, such as a tractor.

Alternatively, the frame can have a coupling device adapted to being connected to a three-point linkage of the tractor vehicle 2. Preferably, the agricultural implement 1 is connected to towing arms or lifting arms (not shown) which form a part of the three-point linkage, but not necessarily to a top link.

Furthermore, the agricultural implement 1 has at least one support wheel 11a, 11b, which can be connected to the frame 10, 101, 102a, 102b, 103a, 103b via a wheel frame 104a, 104b, whose position relative to the frame 10, 101, 102a, 102b, 103a, 103b can be adjustable between an upper position and a lower position.

An actuator 14 can be arranged for controlling the position of the wheel frame 104a, 104b in relation to the frame 10, 101, 102a, 102b, 103a, 103b.

The actuator 14 can be a linear actuator, preferably a hydraulic actuator.

The wheel frame 104a, 104b can be pivotally attached relative to the frame 10, 101, 102a, 102b, 103a, 103b about at least one coupling 141.

The actuator 14 can be pivotally attached relative to the frame 10, 101, 102a, 102b, 103a, 103b and relative to the wheel frame 104a, 104b, so that the linear movement of the actuator 14 can be translated to a movement vertically, through which the vertical position of the wheel 11a, 11b in relation to the frame 10, 101, 102a, 102b, 103a, 103b is adjustable.

It will be appreciated that the wheel frame can be formed in a number of different ways, for example, using a support frame, connected to the frame 10, 101, 102a, 102b, 103a, 103b via a parallel linkage (not shown).

The tools 12, 13 can be spring-loaded and pivotally attached relative to the frame 10, 101, 102a, 102b, 103a, 103b so that they are biased forward to a rest position and so that they can deflect rearward due to loads from the ground through which the tools are drawn and/or when colliding with obstacles, such as stones or other unexpected objects.

Thus, the tools 12, 13 can comprise a tool portion 121, 121′; 131, 131′, pivotal about a coupling 122, 132. At the coupling, a torsion spring arranged at each tool coupling can engage with the tool portion 121, 121′; 131, 131′, in order to bias the tool portion 121, 121′; 131, 131′, to the rest position in a manner known per se.

A torsion spring (not shown) can be formed as a helical spring mounted in pivotal mode, or alternatively as a spring of the type shown in, for example, EP1541003B1, SE534357C2 or WO2014051507A1.

Alternatively, a linear spring, such as a helical spring or a gas spring, can act upon a lever connected to or integrated with the tool portion 121, 121′; 131, 131′.

In an additional alternative, the tools can be entirely or partly formed of resilient material, such as spring steel, wherein the resilience is provided by the tool itself. The agricultural implement 1 is provided with a height sensor 31, which can be arranged on the frame 10, 101, 102a, 102b, 103a, 103b and configured for contact-free measuring of a distance between the frame 10, 101, 102a, 102b, 103a, 103b and a ground surface G1.

Such sensors are known per se, and can use, for example ultrasound, radar or laser for the measurement.

The agricultural implement is further provided with a tool position sensor 32, which can be arranged on the frame or can be integrated with one of the tools 12, 13 and configured for measuring the orientation of the tool in relation to the frame 10, 101, 102a, 102b, 103a, 103b.

For example, the tool position sensor 32 can comprise an angle sensor, connected to the coupling 122, 132, or a distance sensor designed to measure a distance between, for example, the frame 10, 101, 102a, 102b, 103a, 103b and a predetermined portion of the tool portion 121, 121′, 131, 131′.

For example, the tool position sensor 32 can be designed to measure, in a contact-free manner, a distance to the predetermined portion of the tool portion 121, 121′, 131, 131′.

Such a tool position sensor can also use, for example, ultrasound, radar or laser for the measurement, but also a camera with suitable image processing equipment. The tool portion can be provided with some form of mark of identification, reflector or similar (not shown) in order to facilitate the measurement.

Using a tool position sensor 32, with knowledge of the geometry of the tool, it is possible to derive an actual tillage level G3 for the tool, which is not always the same as the theoretical tillage level G4.

Furthermore, the agricultural implement can, but does not have to, comprise a wheel position sensor 33, which can be configured for measuring the position of the wheel 11a, 11b in relation to the frame 10, 101, 102a, 102b, 103a, 103b. Such a wheel position sensor can be formed in the same way as the tool position sensor 32. Alternatively, the wheel position sensor 33 can be configured for determining the position of the actuator 14, which is unique to the wheel position. For example, the wheel position sensor 33 can be designed to determine the position of an actuator piston in the actuator 14.

Using the wheel position sensor, it is possible to determine a wheel track level G2.

A control unit 15 can be arranged on the agricultural implement. The control unit can comprise electronics and control devices for hydraulic functions. Specifically, the control unit can comprise a processing unit, memory and communication units for communication with sensors, other control units and/or user interfaces.

The control unit 15 can be configured to control one, several or all functions of the agricultural implement 1.

Alternatively, the control unit 15 can be arranged outside the agricultural implement 1 itself, such as in a tractor vehicle 2, where it can form part of a control unit which is common for the entire unit.

The control unit 15 has an interface for communication with the sensors 31, 32, 33 arranged on the agricultural implement 1. In addition, the control unit 15 has an interface for controlling the actuator or actuators that control the height position of the support wheels relative to the frame 10, 101, 102a, 102b, 103a, 103b.

The control unit 15 can be configured to receive signals from the height sensor 31 indicating the height above the ground surface of the frame 10, 101, 102a, 102b, 103a, 103b. Such signals can be received continuously, intermittently, on demand by an operator or triggered by any other function.

Furthermore, the control unit 15 can be configured to receive signals from the tool position sensor 32 indicating the orientation and/or the position of the tool relative to the frame 10, 101, 102a, 102b, 103a, 103b.

By configuring the control unit so that it contains data representing a position, at least vertically, for at least one active part of the tool 12, 13 during the soil working in relation to the orientation or the position of the tool relative to the frame 10, 101, 102a, 102b, 103a, 103b, it can derive a height difference between the ground surface G1 and the actual work depth G3 of the tool.

By configuring the control unit 15 so that it contains data representing a position, at least vertically, for the bottom G2 of a wheel track, it is possible to derive a height difference between the bottom of the wheel track and the actual work depth G3 of the tool. This can be relevant later when the difference between the ground surface G1 and the bottom of the wheel track is great, for example when the soil is soft.

The control unit 15 can be configured, based on knowledge of the actual work depth G3, to control the height of the frame relative to the support wheel 11a, 11b using the actuator 14, so that the desired work depth is reached and maintained.

Such controlling can be continuous during driving, intermittent, on demand by an operator or triggered by any other function.

For example, measuring can be continuous, wherein the work depth is re-calculated as a running average value.

As another example, measuring can be intermittent, wherein the work depth is re-calculated as a running average value.

As an additional example, measuring can be triggered by an event, such as a change of direction of travel, a signal from another sensor, a user input or a certain position. A certain signal, such as a change, from the height sensor 31, can, for example, trigger measuring the orientation of the tool. Alternatively, a certain change in the orientation of the tool can trigger a measurement of the height position of the frame.

In addition, it is possible to collect data from the sensors 31, 32, 33 during driving and associate these with position data, for example from GPS, and thereby compile data about the ground conditions, which can be useable at a later time, such as when sowing or harvesting.

A number of various configurations of agricultural implements will be shown below.

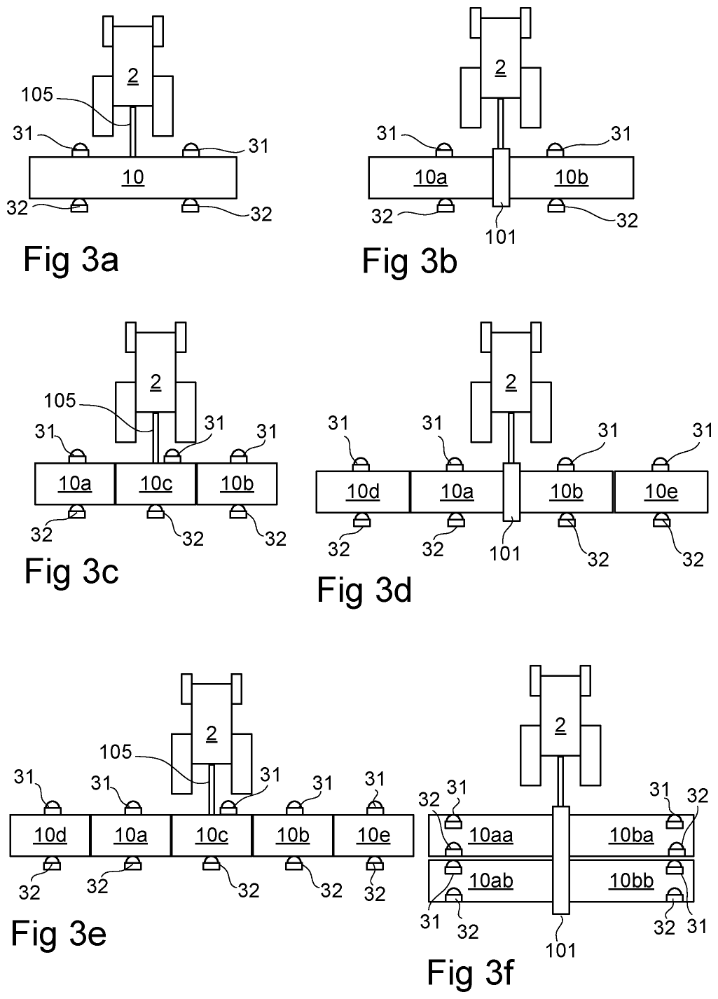

In FIG. 3a, a configuration where the agricultural implement 1 comprises one single frame section 10, carrying one or more sets of tools 12, 13 is shown as described above. In the example shown, the frame section 10 is provided with two sets of sensors 31, 32, arranged at a distance from each other viewed in the transverse direction of the agricultural implement. Each set of sensors can comprise a height sensor, a tool position sensor and, optionally, also a wheel position sensor.

In FIG. 3b, a configuration corresponding to the one in FIG. 2 is shown, e.g. with two frame sections, pivotally attached relative to a main frame section 101 and each carrying one or more sets of tools 12, 13 as described above. The two side frame sections 10a, 10b can be pivotally attached to the main frame 101 in a manner known per se.

In the example shown, each frame section 10a, 10b can be, but does not have to be, provided with a set of sensors.

In FIG. 3c, a configuration with three frame sections 10a, 10b, 10c, which each carry one or more sets of tools 12, 13, is shown as described above. The two side frame sections 10a, 10b can be pivotally attached to a central frame section 10c in a manner known per se.

In the example shown, each frame section 10a, 10b, 10c can be, but does not have to be, provided with a set of sensors.

In FIG. 3d, a configuration with four frame sections 10a, 10b, 10d, 10e, which each carry one or more sets of tools 12, 13, is shown as described above. The two inner side frame sections 10a, 10b can be pivotally attached to a main frame 101 in a manner known per se. The two outer side frame sections 10d, 10e can be pivotally attached to the distal portions of both the inner side frame sections 10a, 10b in a manner known per se.

In the example shown, each frame section 10a, 10b, 10d, 10e can be, but does not have to be, provided with a set of sensors.

In FIG. 3e, a configuration with five frame sections 10a, 10b, 10c, 10d, 10e, which each carry one or more sets of tools 12, 13, is shown as described above. The two inner side frame sections 10a, 10b can be pivotally attached to a central frame section 10c in a manner known per se. The two outer side frame sections 10d, 10e can be pivotally attached to the distal portions of both the inner side frame sections 10a, 10b in a manner known per se.

In the example shown, each frame section 10a, 10b, 10c, 10d, 10e can be, but does not have to be, provided with a set of sensors.

In FIG. 3f, a configuration with two front side frame sections 10aa, 10ba and two rear side frame sections 10ab, 10bb is shown, which can be pivotally attached relative to each other and/or pivotally attached to the main frame 101 in the same way as shown in FIG. 3b.

In the example shown, each frame section 10aa, 10ab, 10ba, 10bb can be, but does not have to be, provided with a set of sensors.

For configurations with front and rear frame sections, which are moveable relative to each other, it is possible to control front and rear sections to different work depths. For example, a front section can have levelling implements or harrow discs, and a rear section can have harrow tines, wherein the rear section is controlled to a greater work depth than the front.

In alternative embodiments, all embodiments of agricultural implements shown in FIGS. 3a-3f can be provided with one, two or more sets of sensors for each frame section 10, 10a, 10b, 10c, 10d, 10e.

According to the examples above, one or more frame sections can be provided with one or more height sensors and/or one or more tool position sensors.

It is thus possible that height sensors and/or tool position sensors are located on all frame sections or only on some frame sections.

It is possible to have, for example, a height sensor on each frame section and a plurality of tool position sensors on the same frame section.

It is possible to have one single height sensor on one section, but tool position sensors on more than one section, and vice versa.

1-14. (canceled)

15. Agricultural implement for soil working, comprising:
a frame,
a number of ground-engaging tools carried by the frame,
at least one rolling ground support, whose height position is adjustable relative to the frame,
a height sensor for contact-free measuring of the height position of the frame relative to a ground surface, and
a control unit, arranged to receive a signal from the height sensor and to control the height position of the rolling ground support,
wherein at least one of the tools is resilient relative to the frame,
wherein the agricultural implement further comprises:
a tool position sensor arranged to measure the orientation of said tool in relation to the frame,
wherein the control unit is arranged to receive a signal from the tool position sensor and to calculate a work depth for said resilient suspended tool based on the signal from the height sensor and based on the signal from the tool position sensor.

16. Agricultural implement according to claim 15, wherein the control unit is configured to control the height position of the rolling ground support based on the signal from the height sensor and based on the signal from the tool position sensor.

17. Agricultural implement according to claim 15, further comprising at least one height position sensor for the rolling ground support, wherein the control unit is arranged to receive a signal from the height position sensor and to calculate the work depth also based on the signal from the height position sensor.

18. Agricultural implement according to claim 15, wherein the height sensor comprises at least one sensor selected from a group consisting of an ultrasonic sensor, a radar sensor and an optical sensor.

19. Agricultural implement according to claim 15, wherein the tool position sensor comprises at least one sensor selected from a group consisting of an ultrasonic sensor, a radar sensor, a light sensor, an angle sensor, a material load sensor and a camera-based sensor.

20. Agricultural implement according to claim 15, further comprising a towing device, configured to be connected to a tractor vehicle using a tow bar or via a pair of lifting arms of a three-point linkage.

21. Agricultural implement according to claim 15, wherein each of the tools is selected from a group consisting of a cultivator tine, a harrow tine, a levelling implement, a plough share, a harrow disc, a breaking-up disc, a furrow-opener, a seed disc, a fertilizer opener and a hoeing tool.

22. Agricultural implement according to claim 15, wherein the agricultural implement, on one and the same frame section, comprises at least two laterally separated height sensors and/or at least two laterally separated tool position sensors, wherein the control unit is configured to calculate the work depth based on signals from at least one of said at least two laterally separated height sensors and based on at least one of said at least two laterally separated tool position sensors.

23. Agricultural implement according to claim 15, wherein the agricultural implement comprises at least two frame sections, which are moveable in relation to each other, wherein at least two of the frame sections have a height sensor and/or a tool position sensor, wherein the control unit is configured to calculate said work depth for each of the frame sections.

24. Agricultural implement according to claim 23, wherein at least two of the frame sections have a rolling ground support associated with each respective frame section, and wherein the control unit is configured to individually control the height position of the rolling ground support of the respective frame sections.

25. Method for determining the work depth of a soil-working agricultural implement, comprising:
providing an agricultural implement comprising:
a frame,
a number of ground-engaging tools carried by the frame, and
at least one rolling ground support, whose height position is adjustable relative to the frame;
measuring a distance between the frame and a ground surface,
measuring the orientation of at least one of said tools relative to the frame, and
based on said distance and said orientation, calculating the work depth of the tool.

26. Method according to claim 25, further comprising controlling said height position based on said distance and said orientation.

27. Method according to claim 25, further comprising measuring a height position for the rolling ground support relative to the frame and calculating the work depth also based on said position of the rolling ground support.

28. Method according to claim 25, wherein at least one of said measurements can be carried out continuously, intermittently or triggered by a predetermined event.
